(19) United States
(12) Patent Application Publication
(10) Pub. No.: US 2021/0097498 A1
(43) Pub. Date: Apr. 1, 2021

(54) EMAIL ENABLED UPDATES OF DATABASE TIME RECORDS

(71) Applicant: SAP SE, Walldorf (DE)

(72) Inventor: Thomas Salvador, Oestringen (DE)

(21) Appl. No.: 16/584,454

(22) Filed: Sep. 26, 2019

(51) Int. Cl. G06Q 10/10; G06F 16/908; G06F 16/9035; G06F 16/906

(52) U.S. Cl. CPC G06Q 10/1091; G06F 16/908; G06F 16/906; G06F 16/9035; G06Q 10/103

(57) ABSTRACT

A method may include sending, to a user, a first email including a template. The template may include one or more projects, each of which including one or more tasks. A second email including a completed template may be received from the user. The completed template may include a time entry for a task associated with a project. A database object including a time record associated with the user may be updated based on the completed template. The database object may be updated by adding, to the time record, the time entry. For example, the time entry may indicate that a quantity of time is spent on the task. Accordingly, a total quantity of time worked by the user may be incremented based on the quantity of time spent on the task. Related systems and articles of manufacture, including computer program products, are also provided.

### TECHNICAL FIELD

The subject matter described herein relates generally to database processing and more specifically to email enabled updates of database time records.

### BACKGROUND

A database may be configured to store a variety of data in the form of electronic data records. For example, a single data record may include one or more fields, each of which holding a value (e.g., an alphanumeric string value, an integer value, a floating-point value, a Boolean value, and/or the like). Individual data records may further be organized into various database objects including, for example, database tables, graphs, and/or the like. Data records stored in the database may be accessed via a database management system (DBMS) coupled with the database. For instance, the database management system may support a variety of operations for accessing the data records held in the database, including, for example, structure query language (SQL) statements, a graph query language statement, and/or the like.

### SUMMARY

Systems, methods, and articles of manufacture, including computer program items, are provided for email enabled updates of database time records. In one aspect, there is provided a system. The system may include at least one data processor and at least one memory. The at least one memory may store instructions that cause operations when executed by the at least one data processor. The operations may include: sending, to a user, a first email including a template, the template including a first project having a first task; receiving, from the user, a second email including a completed template including a first time entry for the first task; and updating, based at least on the completed template, a database object comprising a time record associated with the user, the database object being updated by at least adding, to the time record, the first time entry.

In some variations, one or more features disclosed herein including the following features can optionally be included in any feasible combination. The template may include a second project having a second task. The completed template may include a second time entry for the second task. The database object may be further updated by at least adding, to the time record, the second time entry.

In some variations, the first time entry may include a first numerical value corresponding to a first quantity of time. The first entry may further include an annotation indicating that the first quantity of time was spent on the first project. The database object may be updated by at least incrementing, based at least on the first quantity, a total quantity of time worked by user during a time period associated with the time record.

In some variations, the first time entry may further include a second numerical value corresponding to a second quantity of time and an annotation indicating that the second quantity of time is required to complete the task. The first task may be determined to be incomplete based at least on the annotation. In response to the first task being incomplete a threshold quantity of time before a deadline associated with the first task and/or the first project, a notification including a reminder of the deadline associated with the first task and/or the first project may be sent to the user.

In some variations, in response to the first time entry not including a second numerical value corresponding to a date, the first quantity of time may be associated with a default date comprising a date of the second email.

In some variations, the first time entry may include an annotation indicating that the first task is complete. The first project may be determined to be complete based at least on a completion of the first task.

In some variations, the template may be configured to receive one or more inputs including the first time entry.

In some variations, the first email may be sent in response to a request from the user. The request may be a third email, a short messaging service (SMS) message, and/or a web service request.

In another aspect, there is provided a method for email enabled updates of database time records. The method may include: sending, to a user, a first email including a template, the template including a first project having a first task; receiving, from the user, a second email including a completed template including a first time entry for the first task; and updating, based at least on the completed template, a database object comprising a time record associated with the user, the database object being updated by at least adding, to the time record, the first time entry.

In some variations, one or more features disclosed herein including the following features can optionally be included in any feasible combination. In some variations, one or more features disclosed herein including the following features can optionally be included in any feasible combination. The template may include a second project having a second task. The completed template may include a second time entry for the second task. The database object may be further updated by at least adding, to the time record, the second time entry.

In some variations, the first time entry may include a first numerical value corresponding to a first quantity of time. The first entry may further include an annotation indicating that the first quantity of time was spent on the first project. The database object may be updated by at least incrementing, based at least on the first quantity, a total quantity of time worked by user during a time period associated with the time record.

In some variations, the first time entry may further include a second numerical value corresponding to a second quantity of time and an annotation indicating that the second quantity of time is required to complete the task. The method may further include: determining, based at least on the annotation, that the first task is incomplete; and in response to the first task being incomplete a threshold quantity of time before a deadline associated with the first task and/or the first project, sending, to the user, a notification including a reminder of the deadline associated with the first task and/or the first project.

In some variations, the method may further include in response to the first time entry not including a second numerical value corresponding to a date, associating the first quantity of time with a default date comprising a date of the second email.

In some variations, the first time entry may include an annotation indicating that the first task is complete. The first project may be determined to be complete based at least on a completion of the first task.

In some variations, the first email may be sent in response to a request from the user. The request may be a third email, a short messaging service (SMS) message, and/or a web service request.

In another aspect, there is provided a computer program product including instructions. The instructions may cause operations may executed by at least one data processor. The operations may include: sending, to a user, a first email including a template, the template including a first project having a first task; receiving, from the user, a second email including a completed template including a first time entry for the first task; and updating, based at least on the completed template, a database object comprising a time record associated with the user, the database object being updated by at least adding, to the time record, the first time entry.

Implementations of the current subject matter may include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to email enabled time recording, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating a tracking system, in accordance with some example embodiments;

FIG. 2A depicts an example of an email for updating a time record, in accordance with some example embodiments;

FIG. 2B depicts another example of an email for updating a time record, in accordance with some example embodiments;

FIG. 3 depicts another example of an email for updating a time record, in accordance with some example embodiments;

FIG. 4 depicts a flowchart illustrating a process for updating a time record, in accordance with some example embodiments; and

FIG. 5 depicts a block diagram illustrating a computing system, in accordance with some example embodiments.

When practical, similar reference numbers denote similar structures, features, or elements.

### DETAILED DESCRIPTION

A database may store data that is generated at regular intervals. For example, the database may store database objects corresponding to one or more time records, each of which being a data structure storing one or more values that have accrued over a time period. Accordingly, a time record may correspond to a timesheet tracking one or more quantities of time worked by an employee over a time period such as, for example, a day, a week, a month, and/or the like. Furthermore, valuation operations such as, for example, determining a total quantity of time worked by the employee during a particular time period, may be performed based on a corresponding time record. Nevertheless, updating a time record stored in the database may be a convoluted and time-consuming task that requires a user to generate numerous time entries. As such, in some example embodiments, a tracking engine may be configured to send, to a user, a template generated to include one or more tasks associated with the user. The user may complete the template by at least inputting, for each task, one or more numerical values corresponding to quantities of time. A time record associated with the user may be updated by at least sending, to the tracking engine, the completed template.

The user may be assigned a project including one or more tasks. Accordingly, in some example embodiments, the tracking engine may generate the template to include the one or more tasks. For instance, the template may be configured to receive, from the user, a time entry for at least one task associated with the user. The user may complete the template by at least inputting, for the task, a time entry. The time entry may include, for example, a first quantity of time and/or a second quantity of time. Moreover, the time entry may include one or more annotations providing a description for the first quantity of time, the second quantity of time, and/or the task. For example, the time entry may include one or more annotations indicating, for example, that the first quantity of time was spent on the task and/or the second quantity of time remains to complete the task. Alternatively and/or additionally, the one or more annotations may indicate a status of the task such as, for example, the completion of the task. The completed template may be sent to the tracking engine such that the tracking engine may update, based at least on the completed template, the time record associated with the user.

In some example embodiments, the tracking engine may further generate, based at least on the completed template, one or more notifications. The project and/or the one or more tasks included in the project may be associated with a deadline. Accordingly, the tracking engine may generate a notification if the completed template received less than a threshold quantity of time before the deadline fails to include an annotation indicating the completion of the one or more tasks. The notification may include a reminder of the deadline associated with the project and/or the one or more tasks. Alternatively and/or additionally, the notification may prompt the user to further update the time entry for the one or more tasks included in the project.

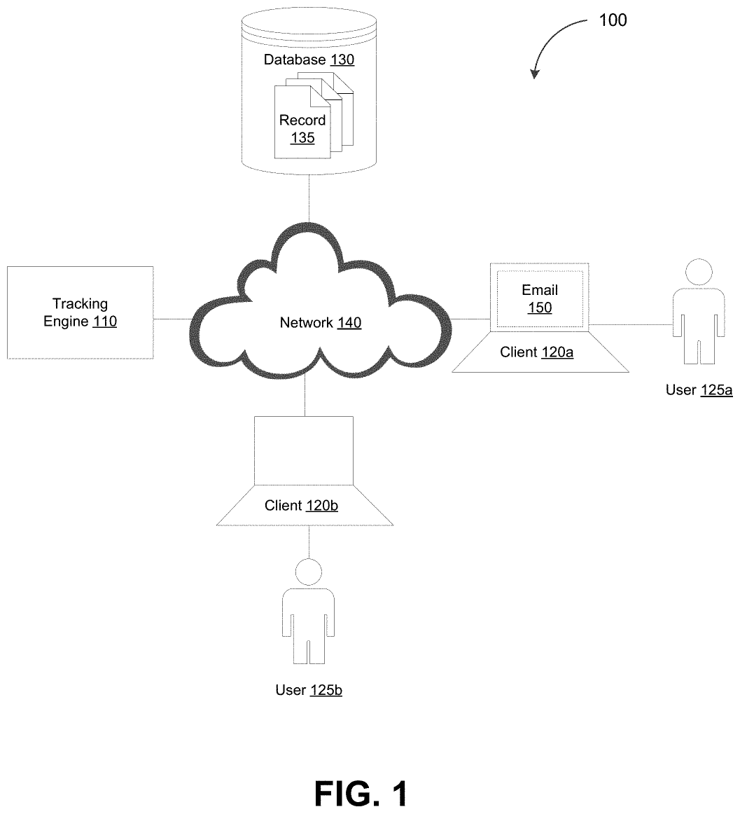

FIG. 1 depicts a system diagram illustrating a tracking system 100, in accordance with some example embodiments. Referring to FIG. 1, the tracking system 100 may include a tracking engine 110 that is communicatively coupled with a first client 120a, a second client 120b, and a database 130. The first client 120a and the second client 120b may each be a processor and memory based device including, for example, a cellular phone, smart phone, a tablet, a laptop computer, a desktop, a workstation, and/or the like. The database 130 may be any type of database including, for example, a graph database, an in-memory database, a relational database, a non-SQL (NoSQL) database, and/or the like. The network 140 may be a wired and/or wireless network including, for example, a public land mobile network (PLMN), a local area network (LAN), a wide area network (WAN), a virtual local area network (VLAN), the Internet, and/or the like.

The database 130 may store a plurality of records including, for example, a record 135 and/or the like. The record 135 may be a time record, which may be a data structure storing one or more values that have accrued over a time period. For example, the record 135 may be a timesheet tracking, based on inputs (e.g., time entries and/or the like) received from the first client 120a, one or more quantities of time worked by a first user 125a at the first client 120a. The record 135 may be a timesheet tracking the quantities of time worked by the first user 125a over a time period such as, for example, a day, a week, a month, and/or the like. In some example embodiments, the tracking engine 110 may update the record 135 including by adding, for example, one or more time entries. Furthermore, the tracking engine 110 may perform, based on the record 135, one or more valuation operations to determine, for example, the total quantity of time the first user 125a worked during at least a portion of the time period associated with the record 135.

In some example embodiments, the tracking engine 110 may support email enabled updates to the record 135. For example, the tracking engine 110 may send, to the first client 120a, an email 150 including a template. The template may include one or more tasks associated with the first user 125a. For instance, a second user 125b at the second client 125b may assign, to the first user 125a, one or more projects including by sending, to the tracking engine 110, an indication of the first user 125a being assigned the one or more projects. To complete a project, the first user 125a may be required to complete one or more tasks included in the project. For example, the first user 125a may be assigned a first project including a first task and a second task as well as a second project including a third task. Accordingly, the tracking engine 110 may generate the template to include the first task, the second task, and the third task.

The template may be configured to receive a time entry for each of the first task, the second task, and the third task. That is, the first user 125a may complete the template and generate a response to the email 150 that includes the completed template. The first user 125a may complete the template by at least inputting a time entry for the first task, the second task, and/or the third task. A single time entry may include, for example, one or more numerical values corresponding to quantities of time. Furthermore, the time entry may include one or more annotations, which may be in any language. The tracking engine 110 may update, based at least on the time entries included in the template, the record 135.

In some example embodiments, the first user 125a may also provide a time entry for one or more of the first task, the second task, and the third task without a template. Instead, the first user 125a may generate the email 150 to include a time entry for one or more of the first task, the second task, and the third task. Furthermore, the first user 125a may send, to the tracking engine 110, the email 150 including the time entry for one or more of the first task, the second task, and the third task. The tracking engine 110 may update, based at least on the email 150, the record 135.

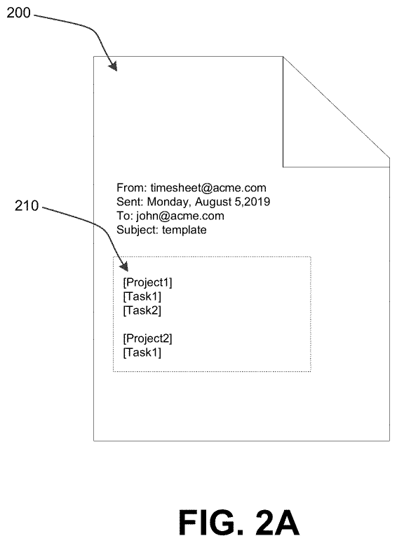

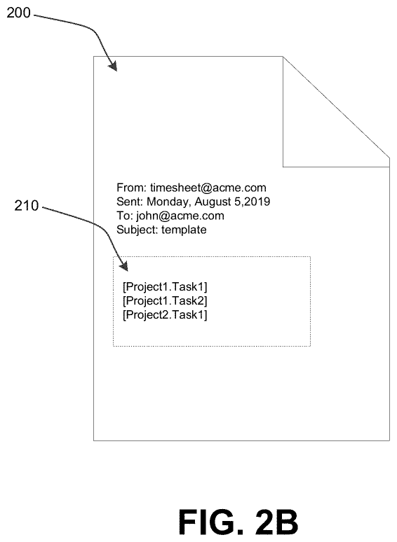

To further illustrate, FIGS. 2A-B depict examples of a first email 200 for updating the record 135, in accordance with some example embodiments. Referring to FIGS. 1 and 2A, the tracking engine 110 may send, to the first user 125a, the first email 200 including a template 210. The tracking engine 110 may send the first email 200 including the template 210 based on a schedule, for example, on a daily basis, a weekly basis, a monthly basis, and/or the like). Alternatively and/or additionally, the tracking engine 110 may send the first email including the template 210 in response to a request from the first user 125a. The request may be sent to the tracking engine 110 via, for example, another email, a short messaging service (SMS) message, or a web service request (e.g., representational state transfer (REST), simple object access protocol (SOAP), and/or the like).

In some example embodiments, the first user 125a may be assigned a first project Project1 including a first task Task1 and a second task Task2 as well as a second project Project2 including a third task Task3. For example, the second user 125b at the second client 125b may assign, to the first user 125a, the first project Project1 and the second project Project2 including by sending, to the tracking engine 110, a corresponding indication. Accordingly, the tracking engine 110 may generate the template 210 to include the first task Task1 and the second task Task2 from the first project Project1 as well as the third task Task1 from the second project Project2.

As shown in FIGS. 2A-B, the template 210 may be structured to avoid ambiguities between identically named tasks such as, for example, the first task Task1 included in the first project Project1 and the third task Task1 included in the second project Project2. In the example shown in FIG. 2A, the template 210 may enumerate the first task Task1, the second task Task2, and the third task Task1 hierarchically as part of the corresponding project. Alternatively, in the example shown in FIG. 2B, the template 210 may include the first task Task1 concatenated with the first project Project1, the second task Task2 concatenated with the first project Project1, and the third task Task1 concatenated with the second project Project2.

In some example embodiments, the first user 125a may complete the template 210 by at least inputting a time entry for each of the first task Task1, the second task Task2, and/or the third task Task1. However, it should be appreciated that the first user 125a may also input a time entry for each of the first task Task1, the second task Task2, and/or the third task Task1 without the template 210. Instead, the first user 125a may generate an email including the time entry for each of the first task Task1 , the second task Task2, and/or the third task Task1. Furthermore, the first user 125a may send, to the trakcing engine 110, the email without being prompted by, for example, the first email 200 including the template 210.

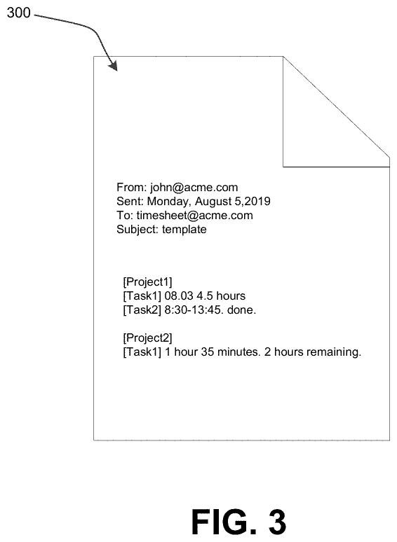

To further illustrate, FIG. 3 depicts an example of a second email 300 for updating the record 135, in accordance with some example embodiments. Referring to FIG. 3, the first user 125a may generate the second email 300 to include a first time entry for the first task Task1, a second time entry for the second task Task2, and/or a third time entry for the third task Task1. The first time entry, the second time entry, and/or the third time entry may include one or more numerical values corresponding to quantities of time. Moreover, the first time entry, the second time entry, and/or the third time entry may include one or more annotations providing a description of the corresponding quantities of time and/or task. In some example embodiments, the first user 125a may generate the second email 300 by at least completing the template 210 included in the first email 200 and responding to the first email 200 with the second email 300 including the completed template 210. Alternatively, the first user 125a may generate the second email 300 without the template 210.

To update the record 135 associated with the first user 125a, the first user 125a may send, to the tracking engine 110, the second email 300. In response to receiving the second email 300, the tracking engine 110 may update, based at least on the first time entry for the first task Task1, the second time entry for the second task Task2, and/or the third time entry for the third task Task1, the record 135 associated with the first user 125a. For example, the tracking engine 110 may increment, based at least on the first time entry for the first task Task1, the second time entry for the second task Task2, and/or the third time entry for the third task Task1, the total quantity of time the first user 125a worked during the time period associated with the record 135.

Referring again to FIG. 3, the first user 125a may input the first time entry to include a first numerical value corresponding to 4 hours and 30 minutes. The first time entry may also include a second numerical value “08.03” corresponding to the date August 3. As such, the first time entry may indicate that the first user 125a spent 4.5 hours on August 3 working on the first task Task1 of the first project Project1. Moreover, in some example embodiments, the tracking engine 110 may resolve the ambiguity arising from the date August 3 missing a year value by at least defaulting to a current year (e.g., 2019). Accordingly, the tracking engine 110 may update the record 135 associated with the first user 125a by at least incrementing the total quantity of time worked by the first user 125a during the time period associated with the record 135 to reflect the first user 125a as having worked 4 hours and 30 minutes on Aug. 3, 2019.

Alternatively and/or additionally, the first user 125a may input the second time entry to include a first numerical value (e.g., 8:30) and a second numerical value (e.g., 13:45) identifying a range of time that corresponds to 5 hours and 15 minutes. The second time entry may further include an annotation indicating a status of the first project Project1 including that the second task Task2 of the first project Project1 is now complete. Because the second time entry fails to specify a date, the tracking engine 110 may default to the current date (e.g., Aug. 5, 2019). Accordingly, the tracking engine 110 may update the record 135 associated with the first user 125a by at least incrementing the total time worked by the first user 125a to reflect the first user 125a as having worked 5 hours and 15 minutes on Aug. 5, 2019. The tracking engine 110 may further update the record 135 to indicate a completion of the second task Task2 of the first project Project1.

It should be appreciated that the tracking engine 110 may update, based on the annotation associated with the second time entry, the record 135 to indicate the completion of the second task Task2 even if the previous status of the second task Task2 indicates that additional time would be required to complete the second task Task2. For example, the previous status of the second task Task2 may indicate that 8 additional hours are still required to complete the second task Task2. Meanwhile, the second time entry indicates that only 5 hours and 15 minutes were spent on the second task Task2. Nevertheless, the tracking engine 110 may update the record 135 to indicate the completion of the second task Task2 because the annotation included in the second time entry indicates that the second task Task2 is complete after the 5 hours and 15 minutes of work.

As shown in FIG. 3, the first user 125a may further input the third time entry to include a first numerical value corresponding to 1 hour and 35 minutes as well as a second numerical value corresponding to 2 hours. The tracking engine 110 may update, based on the third time entry, the record 135 associated with the first user 125a by at least incrementing the total quantity of time worked by the first user 125a during the time period associated with the record 135 to reflect the first user 125a as having worked 1 hour and 35 minutes on Aug. 5, 2019, which may be the default date in the absence of a date from the third time entry. Furthermore, the tracking engine 110 may determine, based at least on the annotation associated with the second numerical value, that 2 additional hours of work are required to complete the third task Task1 of the second project Project2.

As such, the tracking engine 110 may update the record 135 to indicate that 2 additional hours of work are required to complete the third task Task1 of the second project Project2. Moreover, according to some example embodiments, the tracking engine 110 may respond to a fourth time entry indicating the first user 125a as having performed the 2 additional hours of work required to complete the third task Task1 of the second project Project2 by further updating the record 135 to indicate a completion of the third task Task1 of the second project Project2. It should be appreciated that the tracking engine 110 may be configured to update the record 135 to indicate the completion of the third task Task1 of the second project Project2 even if the fourth time entry does not include an annotation from the first user 125a indicating the completion of the third task Task1.

The first project Project1 and the second project Project2 may each be associated with a deadline. Alternatively and/or additionally, each of the first task Task1, the second task Task2, and the third task Task1 may each be associated with a deadline. The tracking engine 110 may set the respective deadlines for the first project Project1, the second project Project2, the first task Task1, the second task Task2, and the third task Task1 based on one or more entries received, for example, from the second user 125b at the second client 120b. For example, the tracking engine 110 may receive, from the second user 125b at the second client 120b, a first entry [Task1] set to 30.10.19 and set the deadline for the first task Task1 to Oct. 30, 2019. The tracking engine 110 may subsequently receive, from the second user 125b at the second client 120b, a second entry [Task1] shift to 25.09.19 and change the deadline for the first task Task1 from Oct. 30, 2019 to Sep. 25, 2019.

The tracking engine 110 may receive, from the second user 125b at the second client 125b, the corresponding as part of the indication assigning the first user 125a the first project Project1 and the second project Project2. In some example embodiments, the tracking engine 110 may generate, based at least on the second email 300, one or more notifications. For example, the tracking engine 110 may generate a notification if the second email 300 is received less than a threshold quantity of time (e.g., a x quantity of days) before the deadline and fails to include an annotation indicating the completion of the one or more tasks. The notification may include a reminder of the deadline associated with the project and/or the one or more tasks. Alternatively and/or additionally, the notification may prompt the first user 125a to further update the time entry for the one or more tasks included in the project.

Referring again to FIG. 3, the second project Project2 and/or the third task Task1 may be associated with a deadline of Aug. 6, 2019. However, the second email 300, which is received on Aug. 5, 2019, does not include an annotation indicating a completion of the first task Task1 associated with the second project Project2. As such, the tracking engine 110 may respond to the second email 300 by at least generating a notification that includes a reminder of the Aug. 6, 2019 deadline associated with the second project Project2 and/or the third task Task1. Alternatively and/or additionally, the tracking engine 110 may generate the notification to prompt the first user 125a to further update the third time entry associated with the third task Task1.

In some example embodiments, the tracking engine 110 may also generate one or more notifications in response to detecting one or more errors in the second email 300. For example, the tracking engine 110 may generate a notification for the first user 125a if the second email 300 includes a discrepancy such as a time entry indicating a quantity of hours worked on a future date, a time entry indicating greater than an allowable quantity of hours worked during a time period (e.g., more than 24 hours worked in a single day), and/or the like. Alternatively and/or additionally, the tracking engine 110 may generate a notification for the first user 125a if the second email 300 includes an ambiguity that cannot be resolved by based on a default value such as the current date. For instance, the second email 300 may include a time entry having multiple quantities of time but no annotations differentiating between quantities of time worked on the task and quantities of time remaining on the task. Because such an ambiguity cannot be resolved based on a default value, the tracking engine 110 may send, to the first user 125a at the first client 120a, a notification prompting the first user 125a to correct the time entry.

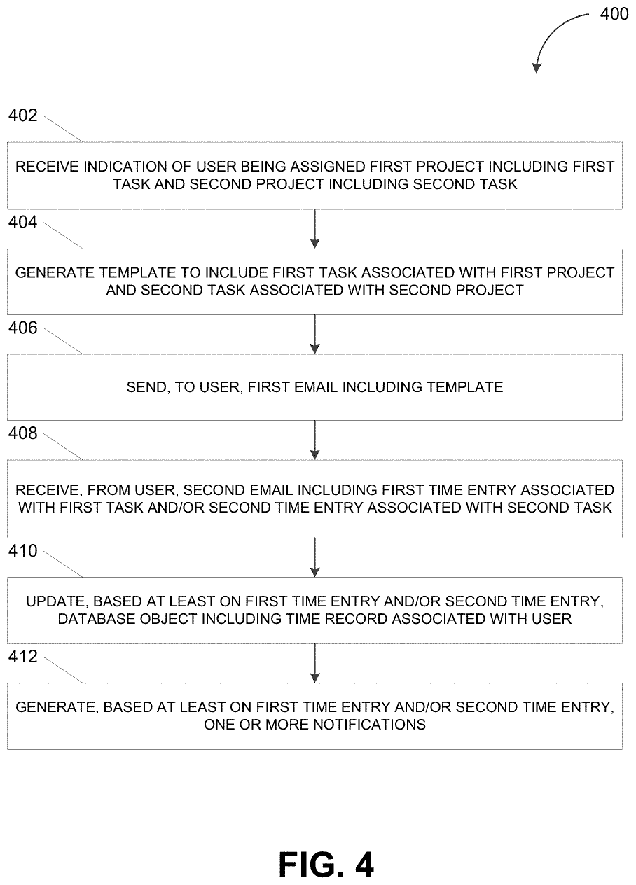

FIG. 4 depicts a flowchart illustrating an example of a process 400 for updating a time record, in accordance with some example embodiments. Referring to FIGS. 1, 2A-B, and 3-4, the process 400 may be performed by the tracking engine 110 in order to update, for example, the record 135 associated with the first user 125a at the first client 120a.

At 402, the tracking engine 110 may receive an indication of a user being assigned a first project including a first task and a second project including a second task. For example, the tracking engine 110 may receive, from the second user 125b at the second client 120b, an indication of the first user 125a being assigned the first project Project1 including the first task first task Task1 and the second task Task2 as well as the second project Project2 including the third task Task1.

At 404, the tracking engine 110 may generate a template to include the first task associated with the first project and the second task associated with the second project. For example, the tracking engine 110 may generate the template 210 to include the first task Task1 and the second task Task2 from the first project Project1 as well as the third task Task1 from the second project Project1. The tracking engine 110 may generate the template 210 based on a schedule (e.g., daily, weekly, monthly, and/or the like) or in response to a request from the first user 125a. To avoid ambiguities between identically named tasks (e.g., the first task Task1 from the first project Project1 and the third task Task1 from the second project Project1), the template 210 may be generated to enumerate the first task Task1, the second task Task2, and the third task Task1 hierarchically as part of the corresponding project. Alternatively, as shown in FIG. 2B, the template 210 may include the first task Task1 concatenated with the first project Project1, the second task Task2 concatenated with the first project Project1, and the third task Task1 concatenated with the second project Project2.

At 406, the tracking engine 110 may send, to the user, a first email including the template. For example, the tracking engine 110 may send, to the first user 125a, the first email 200 including the template 210. As noted, the template 210 may include the first task first task Task1 and the second task Task2 associated with the first project Project1 as well as the third task Task1 associated with the second project Project1.

At 408, the tracking engine 110 may receive, from the user, a second email including a first time entry associated with the first task and/or a second time entry associated with the second task. For example, the tracking engine 110 may receive, from the first user 125a, the second email 300. As noted, the second email 300 may include the template 210 completed by the first user 125a. Alternatively, the first user 125a may generate the second email 300 without the template 210. As shown in FIG. 3, the second email 300 may include the first time entry for the first task Task1, the second time entry for the second task Task2, and/or the third time entry for the third task Task1. The first time entry, the second time entry, and/or the third time entry may include one or more numerical values corresponding to quantities of time. Moreover, the first time entry, the second time entry, and/or the third time entry may include one or more annotations providing a description of the corresponding quantities of time and/or task.

At 410, the tracking engine 110 may update, based at least on the first time entry and/or the second time entry, a database object including a time record associated with the user. In some example embodiments, the tracking engine 110 may update the record 135 associated with the first user 125a by at least incrementing, based at least on the first time entry for the first task Task1, the second time entry for the second task Task2, and/or the third time entry for the third task Task1, the total quantity of time the first user 125a worked during the time period associated with the record 135.

For example, as shown in FIG. 3, the tracking engine 110 may update, based at least on the first time entry for the first task Task1, the record 135 by at least incrementing the total quantity of time worked by the first user 125a during the time period associated with the record 135 to reflect the first user 125a as having worked 4 hours and 30 minutes on Aug. 3, 2019. The tracking engine 110 may further update, based at least on the second time entry for the second task Task2, the record 135 by at least incrementing the total time worked by the first user 125a to reflect the first user 125a as having worked 5 hours and 15 minutes on Aug. 5, 2019 as well as to indicate a completion of the second task Task2 of the first project Project1. Furthermore, the tracking engine 110 may update, based on the third time entry associated with the third task Task1, the record 135 by at least incrementing the total quantity of time worked by the first user 125a during the time period associated with the record 135 to reflect the first user 125a as having worked 1 hour and 35 minutes on Aug. 5, 2019 and that 2 additional hours of work are required to complete the third task Task1 of the second project Project2.

At 412, the tracking engine 110 may generate, based at least on the first time entry and/or the second time entry, one or more notifications. In some example embodiments, the tracking engine 110 may generate, based at least on the second email 300, one or more notifications. For example, the tracking engine 110 may generate a notification if the completed template 150 received less than a threshold quantity of time (e.g., a x quantity of days) before the deadline associated with the second project Project2 and/or the third task Task1 fails to include an annotation indicating the completion of the third task Task1. The notification may include a reminder of the deadline associated with the second project Project2 and/or the third task Task1. Alternatively and/or additionally, the tracking engine 110 may generate the notification to prompt the first user 125a to further update the third time entry associated with the third task Task1.

In some example embodiments, the tracking engine 110 may also generate one or more notifications in response to detecting one or more errors in the second email 300. For example, the tracking engine 110 may generate a notification if the second email 300 includes a discrepancy such as a time entry indicating a quantity of hours worked on a future date, a time entry indicating greater than an allowable quantity of hours worked during a time period (e.g., more than 24 hours worked in a single day), and/or the like. Alternatively and/or additionally, the tracking engine 110 may generate a notification if the second email 300 includes an ambiguity that cannot be resolved by based on a default value such as the current date.

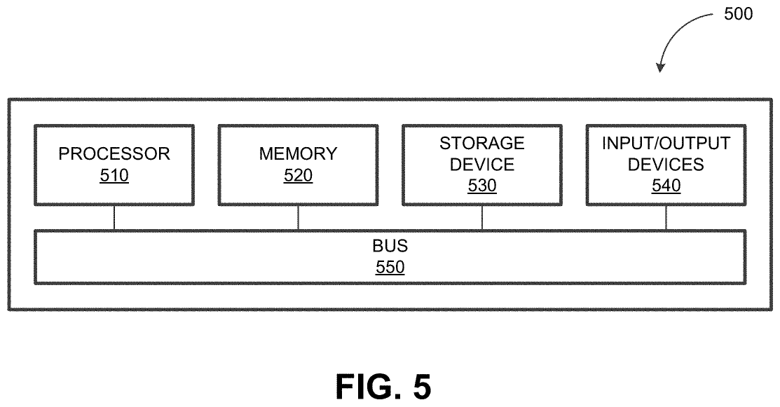

FIG. 5 depicts a block diagram illustrating a computing system 500 consistent with implementations of the current subject matter. Referring to FIGS. 1 and 5, the computing system 500 can be used to implement the tracking engine 110 and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the tracking engine 110. In some example embodiments, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some example embodiments, the input/output device 540 includes a keyboard and/or pointing device. In various implementations, the input/output device 540 includes a display unit for displaying graphical user interfaces.

According to some example embodiments, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some example embodiments, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning as an add-in for a spreadsheet and/or other type of program) or can be standalone computing items and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program item, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
at least one data processor; and
at least one memory storing instructions which, when executed by the at least one data processor, result in operations comprising:
sending, to a user, a first email including a template, the template including a first project having a first task;
receiving, from the user, a second email including a completed template including a first time entry for the first task; and
updating, based at least on the completed template, a database object comprising a time record associated with the user, the database object being updated by at least adding, to the time record, the first time entry.

2. The system of claim 1, wherein the template includes a second project having a second task, wherein the completed template includes a second time entry for the second task, and wherein the database object is further updated by at least adding, to the time record, the second time entry.

3. The system of claim 1, wherein the first time entry includes a first numerical value corresponding to a first quantity of time.

4. The system of claim 3, wherein the first entry further includes an annotation indicating that the first quantity of time was spent on the first project, and wherein the database object is updated by at least incrementing, based at least on the first quantity, a total quantity of time worked by user during a time period associated with the time record.

5. The system of claim 3, wherein the first time entry further includes a second numerical value corresponding to a second quantity of time and an annotation indicating that the second quantity of time is required to complete the task.

6. The system of claim 5, further comprising:
determining, based at least on the annotation, that the first task is incomplete; and
in response to the first task being incomplete a threshold quantity of time before a deadline associated with the first task and/or the first project, sending, to the user, a notification including a reminder of the deadline associated with the first task and/or the first project.

7. The system of claim 3, further comprising:
in response to the first time entry not including a second numerical value corresponding to a date, associating the first quantity of time with a default date comprising a date of the second email.

8. The system of claim 1, wherein the first time entry includes an annotation indicating that the first task is complete, and wherein the first project is determined to be complete based at least on a completion of the first task.

9. The system of claim 1, wherein the template is configured to receive one or more inputs including the first time entry.

10. The system of claim 1, wherein the first email is sent in response to a request from the user, and wherein the request comprises a third email, a short messaging service (SMS) message, and/or a web service request.

11. A computer-implemented method, comprising:
sending, to a user, a first email including a template, the template including a first project having a first task;
receiving, from the user, a second email including a completed template including a first time entry for the first task; and
updating, based at least on the completed template, a database object comprising a time record associated with the user, the database object being updated by at least adding, to the time record, the first time entry.

12. The method of claim 11, wherein the template includes a second project having a second task, wherein the completed template includes a second time entry for the second task, and wherein the database object is further updated by at least adding, to the time record, the second time entry.

13. The method of claim 11, wherein the first time entry includes a first numerical value corresponding to a first quantity of time.

14. The method of claim 13, wherein the first entry further includes an annotation indicating that the first quantity of time was spent on the first project, and wherein the database object is updated by at least incrementing, based at least on the first quantity, a total quantity of time worked by user during a time period associated with the time record.

15. The method of claim 13, wherein the first time entry further includes a second numerical value corresponding to a second quantity of time and an annotation indicating that the second quantity of time is required to complete the task.

16. The method of claim 15, further comprising:
determining, based at least on the annotation, that the first task is incomplete; and
in response to the first task being incomplete a threshold quantity of time before a deadline associated with the first task and/or the first project, sending, to the user, a notification including a reminder of the deadline associated with the first task and/or the first project.

17. The method of claim 13, further comprising:
in response to the first time entry not including a second numerical value corresponding to a date, associating the first quantity of time with a default date comprising a date of the second email.

18. The method of claim 11, wherein the first time entry includes an annotation indicating that the first task is complete, and wherein the first project is determined to be complete based at least on a completion of the first task.

19. The system of claim 1, wherein the first email is sent in response to a request from the user, and wherein the request comprises a third email, a short messaging service (SMS) message, and/or a web service request.

20. A non-transitory computer readable medium storing instructions, which when executed by at least one data processor, result in operations comprising:
sending, to a user, a first email including a template, the template including a first project having a first task;
receiving, from the user, a second email including a completed template including a first time entry for the first task; and
updating, based at least on the completed template, a database object comprising a time record associated with the user, the database obj ect being updated by at least adding, to the time record, the first time entry.
